(19) United States
(12) Patent Application Publication
(10) Pub. No.: US 2013/0221080 A1
(43) Pub. Date: Aug. 29, 2013

(54) Carton with Reinforced Handle

(71) Applicant: Graphic Packaging International, Inc., (US)

(72) Inventors: Raymond R. Spivey, SR., Mableton, GA (US); Jean-Manuel Gomes, Marietta, GA (US); Colin P. Ford, Woodstock, GA (US)

(73) Assignee: Graphic Packaging International, Inc., Atlanta, GA (US)

(21) Appl. No.: 13/778,518

(22) Filed: Feb. 27, 2013

Related U.S. Application Data
(60) Provisional application No. 61/634,305, filed on Feb. 27, 2012.

(51) Int. Cl. B65D 5/00; B31B 1/26

(52) U.S. Cl. CPC B65D 5/00; B31B 1/26
USPC 229/117.09; 493/162

(57) ABSTRACT

A carton for carrying a plurality of articles. The carton comprises a plurality of panels extending at least partially around an interior of the carton. The plurality of panels comprise at least a first top panel, a second top panel, at least one side panel, and a bottom panel. The first top panel and the second top panel are at least partially overlapped. At least one of the first top panel and the second top panel comprise a main portion foldably connected to the at least one side panel and a distal portion foldably connected to the main portion. The main portion has a first handle portion and the distal portion has a second handle portion. The distal portion has an exterior surface at least partially in face-to-face contact with the interior surface of the main portion. The carton further comprises a handle comprising at least the first handle portion and the second handle portion.

### CROSS-REFERENCE TO RELATED APPLICATIONS

This application claims the benefit of U.S. Provisional Patent Application No. 61/634,305 filed Feb. 27, 2012.

### INCORPORATION BY REFERENCE

The disclosure of U.S. Provisional Patent Application No. 61/634,305, which was filed on Feb. 27, 2012, is hereby incorporated by reference for all purposes as if presented herein in their entirety.

### BACKGROUND OF THE DISCLOSURE

The present disclosure generally relates to cartons or carriers for holding beverage containers or other types of articles.

### SUMMARY OF THE DISCLOSURE

In general, one aspect of the disclosure is directed to a carton for carrying a plurality of articles. The carton comprises a plurality of panels extending at least partially around an interior of the carton. The plurality of panels comprise at least a first top panel, a second top panel, at least one side panel, and a bottom panel. The first top panel and the second top panel are at least partially overlapped. At least one of the first top panel and the second top panel comprise a main portion foldably connected to the at least one side panel and a distal portion foldably connected to the main portion. The main portion has a first handle portion and the distal portion has a second handle portion. The distal portion has an exterior surface at least partially in face-to-face contact with the interior surface of the main portion. The carton further comprises a handle comprising at least the first handle portion and the second handle portion.

In another aspect, the disclosure is generally directed to a blank for forming a carton for carrying a plurality of articles. The blank comprises a plurality of panels comprising at least a first top panel, a second top panel, at least one side panel, and a bottom panel, the first top panel and the second top panel are configured to be at least partially overlapped. At least one of the first top panel and the second top panel comprises a main portion foldably connected to the at least one side panel and a distal portion foldably connected to the main portion. The main portion has a first handle portion and the distal portion has a second handle portion. The distal portion has an exterior surface configured to be at least partially in face-to-face contact with the interior surface of the main portion. Features for forming a handle comprise at least the first handle portion and the second handle portion.

In another aspect, the disclosure is generally directed to a method of forming a carton for carrying a plurality of articles. The method comprises obtaining a blank comprising a plurality of panels comprising at least a first top panel, a second top panel, at least one side panel, and a bottom panel. The first top panel and the second top panel are configured to be at least partially overlapped. At least one of the first top panel and the second top panel comprises a main portion foldably connected to the at least one side panel and a distal portion foldably connected to the main portion. The main portion has a first handle portion and the distal portion has a second handle portion. The distal portion has an exterior surface configured to be at least partially in face-to-face contact with the interior surface of the main portion. Features for forming a handle comprise at least the first handle portion and the second handle portion. The method comprises forming at least a portion of an interior of the carton by folding the plurality of panels about the plurality of articles, and forming the handle by positioning the distal portion so that the exterior surface of the distal portion is in face-to-face contact with the interior surface of the main portion. The positioning the distal portion comprises positioning the first handle portion relative to the second handle portion to form the handle.

### BRIEF DESCRIPTION OF THE DRAWINGS

FIG. 1 is a plan view of an exterior surface of a blank of a first embodiment.

FIG. 2 is an expanded view of a handle-forming portion of the blank of FIG. 1.

FIG. 3 is a view of a partially-formed reinforced handle of the blank of FIG. 1.

FIG. 4 is a perspective view of a partially-formed carton formed from the blank of FIG. 1.

FIG. 5 is a perspective view of a carton formed from the blank of FIG. 1.

FIG. 6 is a perspective view of a carton formed from the blank of FIG. 1.

FIG. 7 is a perspective view of a carton formed from the blank of FIG. 1.

FIG. 8 is a perspective view of a carton with an activated handle formed from the blank of FIG. 1.

FIG. 9 is a perspective view of a carton with an activated handle formed from the blank of FIG. 1

FIG. 10 plan view of exterior surface of a blank of a second embodiment.

FIG. 11 plan view of exterior surface of a blank of a third embodiment.

Corresponding parts are designated by corresponding reference numbers throughout the drawings.

### DETAILED DESCRIPTION OF THE EXEMPLARY EMBODIMENTS

The present disclosure generally relates to various features for cartons, cartons, packages, containers, etc., that contain articles such as containers, bottles, cans, boxes, etc. The articles can be used for packaging food and beverage products, for example. The articles can be made from materials suitable in composition for packaging the particular food or beverage item, and the materials include, but are not limited to, paperboard, composite paperboard and plastic, aluminum and/or other metals; glass; plastics such as PET, LDPE, LLDPE, HDPE, PP, PS, PVC, EVOH, and Nylon; and the like, or any combination thereof.

Cartons or carriers according to the present disclosure can accommodate articles of any shape. For the purpose of illustration and not for the purpose of limiting the scope of the disclosure, the following detailed description describes beverage containers (e.g., brick-shaped containers) as disposed within the carton embodiments. In this specification, the terms “lower,” “bottom,” “upper” and “top” indicate orientations determined in relation to fully erected and upright cartons.

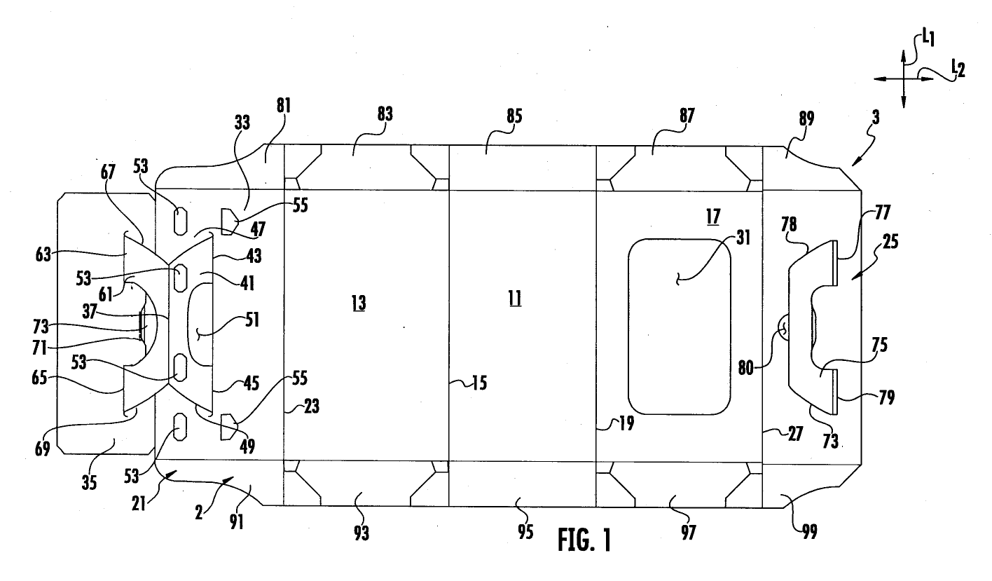

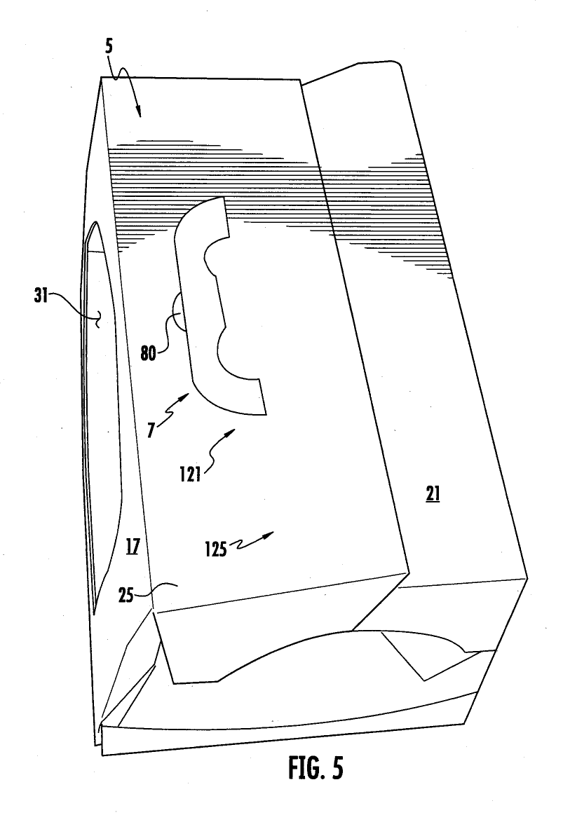

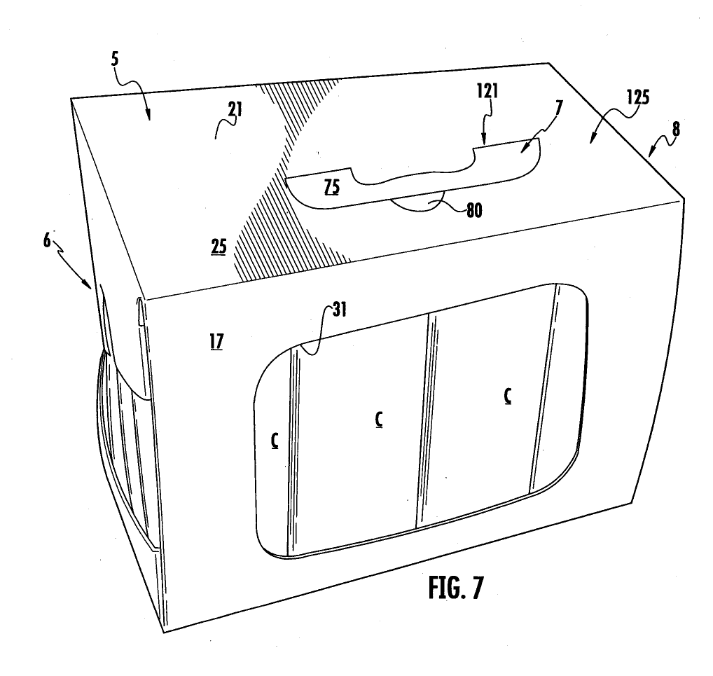

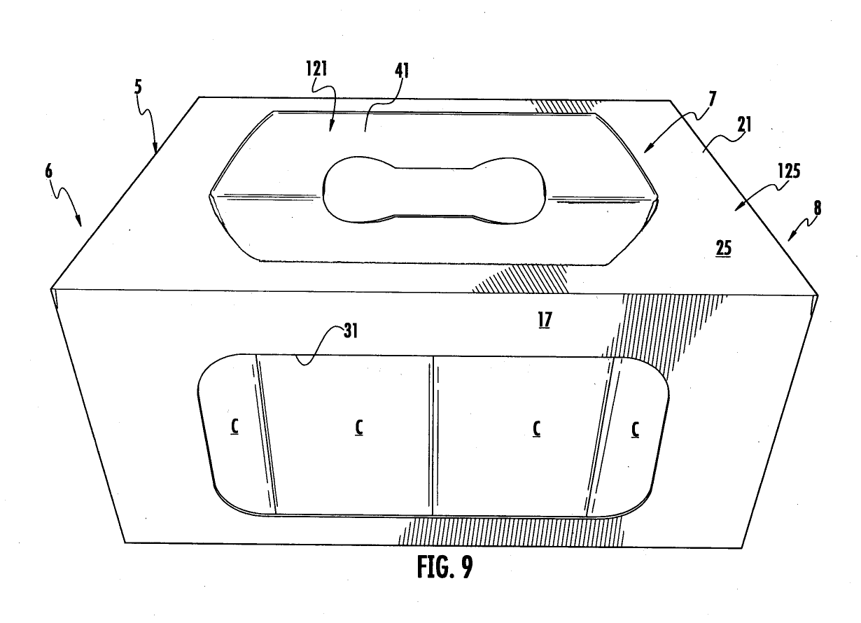

FIG. 1 is a plan view of an exterior surface 2 of a blank 3, used to form a carton 5, shown in FIGS. 5-9, according to one embodiment of the disclosure. The carton 5 can be used to house a plurality of articles such as containers C. In one embodiment, the containers C can be brick-shaped containers commonly referred to as TETRA PAK© containers that contain a liquid beverage or other food or beverage product. The containers C can be any suitable container such as any shape, size, and type of container that is commercially available from Tetra Pak International SA, Lausanne, Switzerland, such as TETRA BRIK packages, TETRA BRIK ASEPTIC packages, TETRA PRISM ASEPTIC packages, or any other suitable package or container (see www.tetrapak.com for more information). The containers C could be other suitable containers made from other materials by other manufactures (e.g., PET bottles, yogurt containers, juice-boxes, beverage cans, etc.) without departing form the disclosure.

In one embodiment, the blank 3 is sized to form a carton 5 that contains twelve containers C or packages in a single layer in a 3×4 arrangement. But, it is understood that the blank 3 and/or carton 5 may be sized and shaped to hold containers C of a different or same quantity in more than one layer and/or in different row/column arrangements (e.g., 1×6, 2×3, 2×6, 2×4, 2×2, 2×6×2, 2×4×2, 2×9, etc.). In the illustrated embodiment, the carton 5 has at least partially open ends 6, 8 and generally wraps around the containers C contacting the top and bottom of the group of containers. In one embodiment, the carton 5 may be referred to as a “wrap-around carton or carrier”. Alternatively, the carton 5 could be a carton with ends that are closed by one or more end flaps with the containers being loaded into the partially formed carton prior to closing one or more ends of the carton without departing from the disclosure.

The carton 5 has a reinforced handle 7 that is used for grasping and carrying the carton. The handle 7 is formed by multiple layers of material of the blank 3 so that the handle is strengthened to reduce handle failure. For example, according to one embodiment, the handle 7 comprises two or more layers of material. According to another embodiment, the handle 7 comprises three layers of material.

As shown in FIG. 1, the blank 3 has a longitudinal axis L1 and a lateral axis L2. In the illustrated embodiment, the blank 3 comprises a bottom panel 11 foldably connected to a first side panel 13 at a lateral fold line 15, a second side panel 17 foldably connected to the bottom panel at a lateral fold line 19, a first top panel 21 foldably connected to the first side panel at a lateral fold line 23, and a second top panel 25 foldably connected to the second side panel 17 at a lateral fold line 27.

In one embodiment, the second side panel 17 includes an opening or window 31. The first top panel 21 includes a main portion 33 foldably connected to the first side panel 13 at the fold line 23 and a distal portion 35 foldably connected to the main portion by a lateral fold line 37. The main portion 33 has a first handle portion 41 foldably connected to the main portion at lateral fold lines 43, 45 and at least partially defined by tear lines 47, 49. An elongate handle opening 51 is adjacent the first handle portion 41 in the main portion 33 of the first top panel 21. The main portion 33 of the first top panel 21 has a first plurality of openings 53 that are generally aligned in the longitudinal direction L1 and are spaced apart in the longitudinal direction L1, and a second plurality of openings 55 that are generally aligned in the longitudinal direction and are spaced apart in the longitudinal direction. As will be discussed later below, the openings 53, 55 allow glue to pass through the main portion 33 of the first top panel 21 to a panel located below the main portion to facilitate forming of strengthening features of the handle 7.

In the first embodiment, the distal portion 35 includes a second handle portion 61 foldably connected to the first handle portion 41 at the lateral fold line 37. The second handle portion 61 is foldably connected to the distal portion 35 are lateral fold lines 63, 65 and is at least partially defined by arcuate cuts 67, 69 extending from a respective tear line 47, 49 to a respective fold line 63, 65. Also, the second handle portion 61 is defined by a curved cut 71 extending between a central portion of the second handle portion and defining a comfort flap 73 adjacent to the second handle portion.

As shown in FIG. 1, the second top panel 25 includes a third handle portion 75 foldably connected to the second top panel at two lateral fold lines 76, 77. The third handle portion 75 is at least partially defined by tear lines 78, 79 and an opening 80 is adjacent to the third handle portion. The first handle portion 41, second handle portion 61, and third handle portion 75 combine to form the handle 7 in a manner that will be described in further detail below. One or more of the handle portions 41, 61, 75 could be otherwise shaped, arranged, and/or omitted without departing form the disclosure.

In one embodiment, the panels 11, 13, 17, 21, 25 have respective first end flaps 81, 83, 85, 87, 89 at a first marginal portion of the blank 3 such that the first end flaps are foldably connected to respective panels by a longitudinal fold line 90. The panels 11, 13, 17, 21, 25 have respective second end flaps 91, 93, 95, 97, 99 at a second marginal portion of the blank 3 such that the second end flaps are foldably connected to respective panels by a longitudinal fold line 100. The first end flaps 81, 83, 85, 87, 89 are for closing the first end 6 of the carton 5 and the second end flaps 91, 93, 95, 97, 99 are for closing the second end 8 of the carton. One or more of the first end flaps 81, 83, 85, 87, 89 and second end flaps 91, 93, 95, 97, 99 can be foldably connected to each other at respective fold lines, or one or more of the end flaps can have respective gussets or webs foldably connecting adjacent first or second end flaps or one or more of the end flaps can be tuck-in panels or flaps without departing from the disclosure. The end flaps could be otherwise shaped, arranged, configured, and/or omitted without departing from the disclosure.

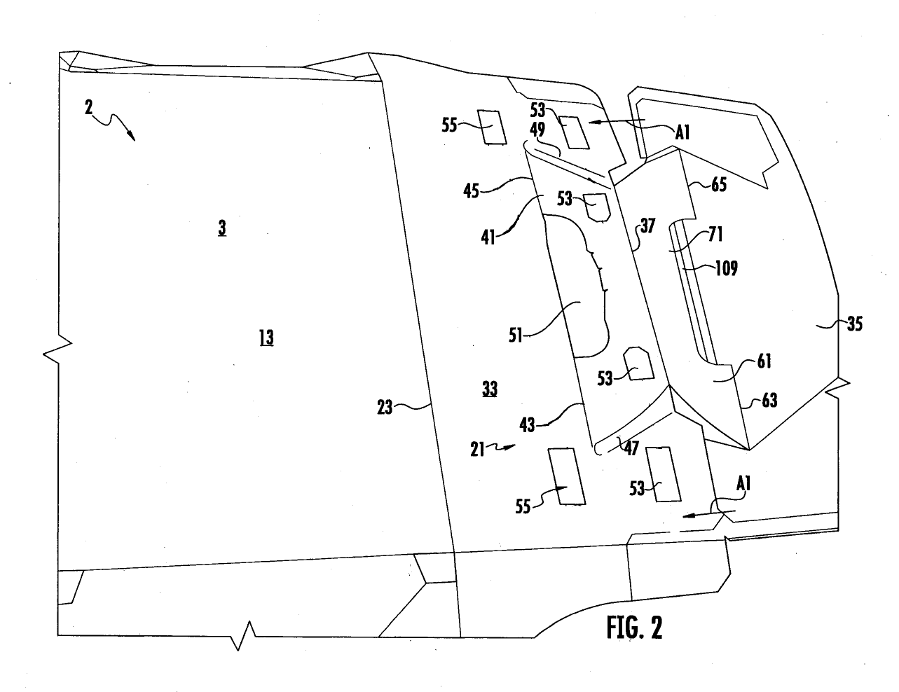

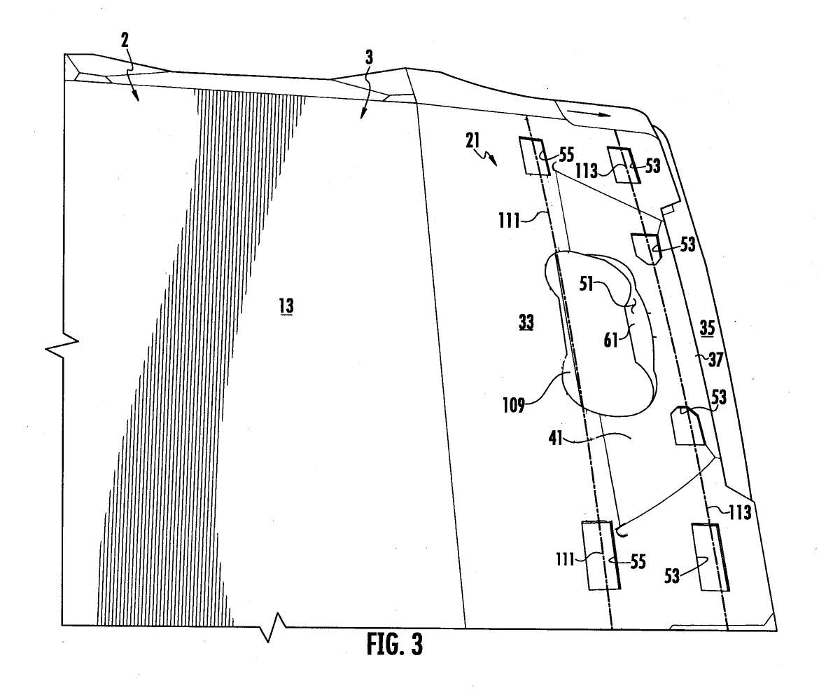

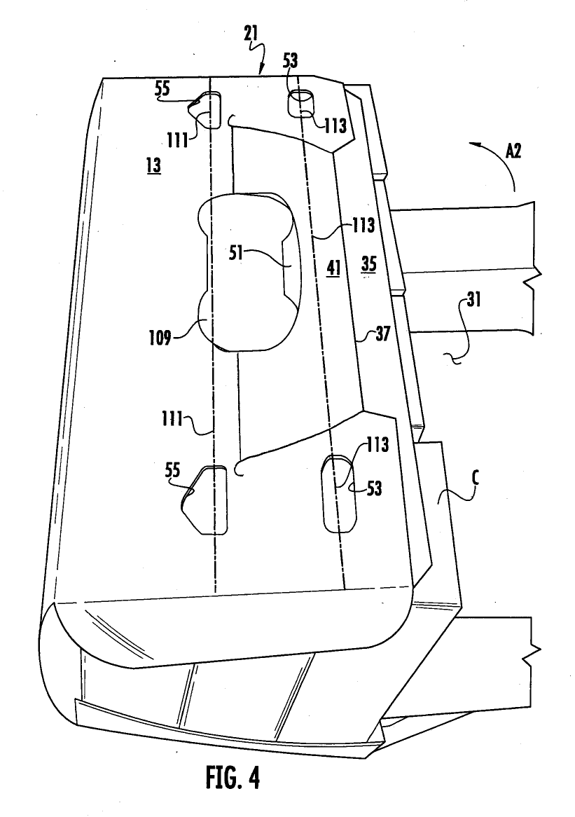

FIGS. 2-9 show various views and features of one exemplary method of forming the blank 3 into the carton 5. The blank is first placed with the interior surface 105 facing up and containers C are placed on the bottom panel 11. Prior to or after placing the containers C on the bottom panel 11, the distal portion 35 of the first top panel 21 can be positioned relative to the main portion 33 as shown in FIGS. 2-3 to begin forming the reinforced handle 7. The distal portion 35 is positioned such that the second handle portion 61 is folded underneath the first handle portion 41 about the fold line 37 with the interior surface of the second handle portion being in face-to-face contact with the interior portion of the first handle portion (FIG. 3). The remaining portion of the distal portion 35 other than the second handle portion 61 is slid underneath the folded over second handle portion with the exterior surface of the remaining portion of the distal portion being in face-to-face contact with the exterior surface of the second handle portion (previously folded under the first handle portion 41) and interior surface of the main portion 33 of the first top panel 21. As shown in FIGS. 3-4, a leading edge portion 109 of the distal portion 35 that is formed by the cut 71 (shown in FIG. 1 as extending between portions of the second handle portion 61 in the blank 3) is inserted through the opening 51 adjacent the first handle portion 41. When the main portion 33 and distal portion 35 of the first top panel 21 are positioned as shown in FIGS. 3-4, glue 111, 113 or other adhesive can be applied as indicated. The glue 111 can be applied in a laterally extending line across openings 55, leading edge portion 109, and the exterior surface of the distal portion 35. The glue 113 can be applied in a laterally extending line across openings 53, the first handle portion 41 and the exterior surface of the main portion 31. The glue 111, 113 applied across the openings 53, 55 is applied to the distal portion 35 that is located below the openings. The glue 111, 113 could be otherwise applied in other shapes, and configuration other than a line, without departing from the disclosure.

In one embodiment, the leading edge portion 109 of the distal portion 35, or other features of the handle 7, can have engaging or locking features that engage one or more features or portions of the main portion 33 or other feature to allow the handle 7 to be formed without the need for glue or tape. In one embodiment, the folding of the distal portion 35 relative to the main portion 33 of the first top panel 21 from the position of FIG. 2 to the position of FIG. 3 can be a “Z-fold” with the handle portion 61 being folded relative to the handle portion 41 at fold line 37 and the distal portion 35 being moved or slid in the direction of arrow Al so that the exterior surface of the distal portion generally fits below the interior surface of the main portion as the handle portion 61 folds under the handle portion 41. Alternatively, the leading edge portion 109 can be glued or taped to the underside of the main portion 33, rather than inserted through opening 51 without departing from the disclosure. Further, the handle 7 could be formed by other features or the features shown and described herein could be otherwise shaped, arranged, configured, and/or omitted without departing from the disclosure.

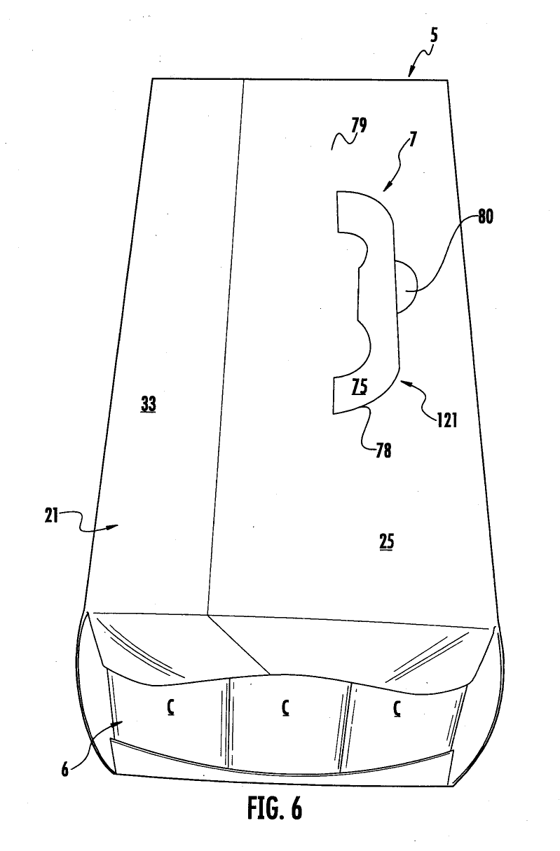

As shown in FIGS. 4-6, the blank 3 is further formed around the container C such that the second top panel 21, with the main portion 33 and distal portion 35, positioned as described above, contacts the tops of the containers. The second side panel 17 can be folded up against the containers in the direction of arrow A2 and the second top panel 25 positioned to overlap the first top panel 21 as shown in FIGS. 5 and 6. The third handle portion 75 overlaps the first handle portion 41 and is adhered to the first handle portion by the glue 113 applied to the first handle portion. Further, the second top panel 25 is secured to the folded under distal portion 35 through the openings 53, 55 in the main portion by the glue that is located in the openings 55. Also, the second top panel 35 is secured to the leading edge portion 109 by the glue 111 applied to the leading edge portion.

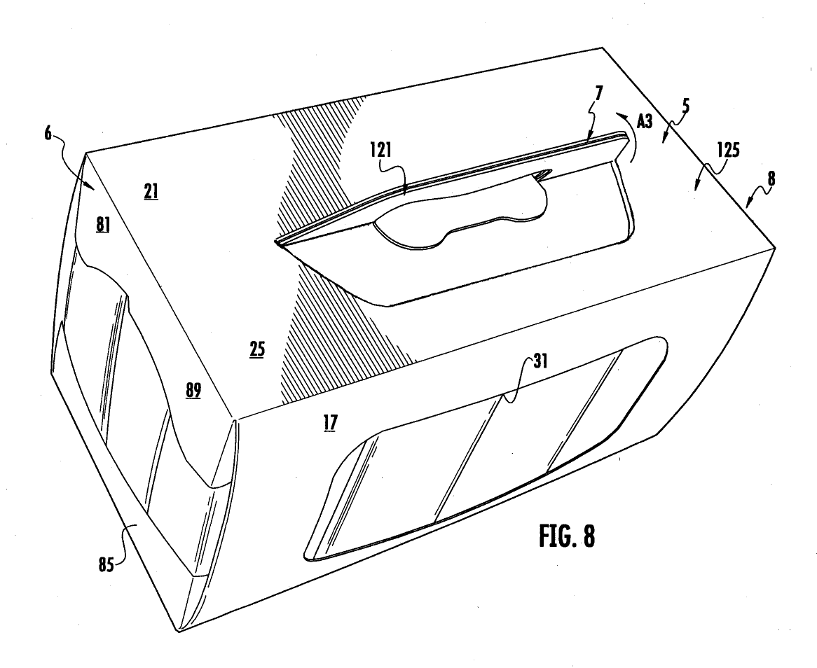

The handle 7 of the carton 5 includes a reinforced handle portion 121 that is formed by the three handle portions 41, 61, 75 that are overlapped and adhered in the manner described above or an alternative method of forming. The reinforced handle portion 121 can be grasped at the opening 80 and lifted in the direction of arrow A3 by tearing along tear lines 47, 49, and 78, 79 to separate the reinforced handle portion from the first top panel 21 and second top panel 25, as shown in FIG. 8. The carton 5 includes a reinforced top panel 125 that is formed by the overlapping and adhering of the three layers of material (e.g., the distal portion 35 of the first top panel 21, the main portion 33 of the first top panel, and the second top panel 25).

The first end 6 of the carton can be at least partially closed by positioning the first end flaps 81, 83, 85, 87, 89 and the second end 8 of the carton can be at least partially closed by positioning the second end flaps 91, 93, 95, 97, 99. In alternative embodiments, the ends 6, 8 can be fully open or fully closed without departing from the disclosure.

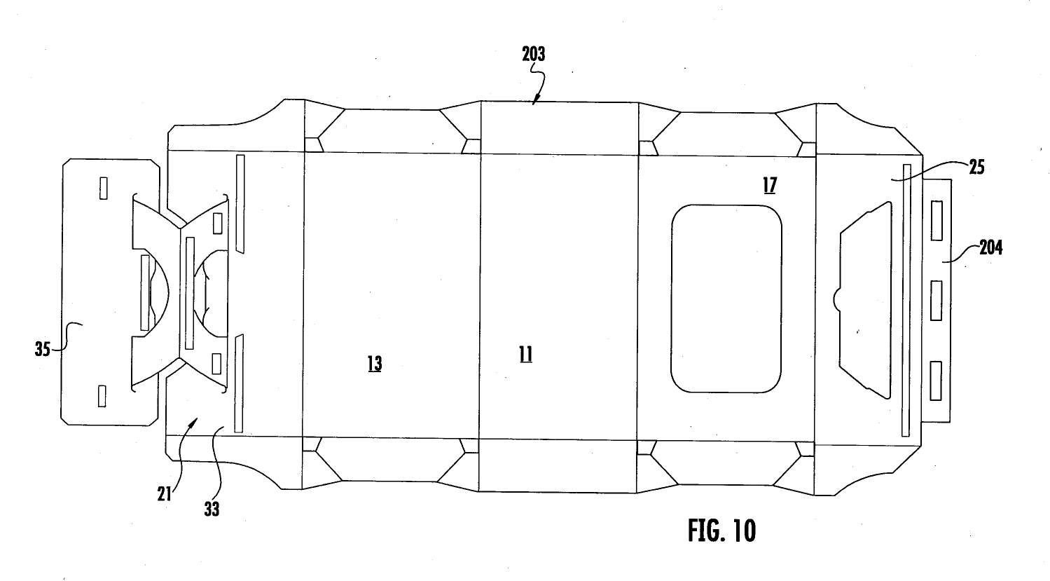

FIG. 10 shows a blank 203 of a second embodiment of the disclosure having similar features as the first embodiment. Accordingly, similar or identical features of the embodiments are provided with identical or similar reference numbers. The blank 203 includes a glue flap 204 foldably attached to the second top panel 25 that is for adding strength to a carton formed from the blank 203 and for preventing tearing of the handle from respective corners of the carton formed from the blank 203.

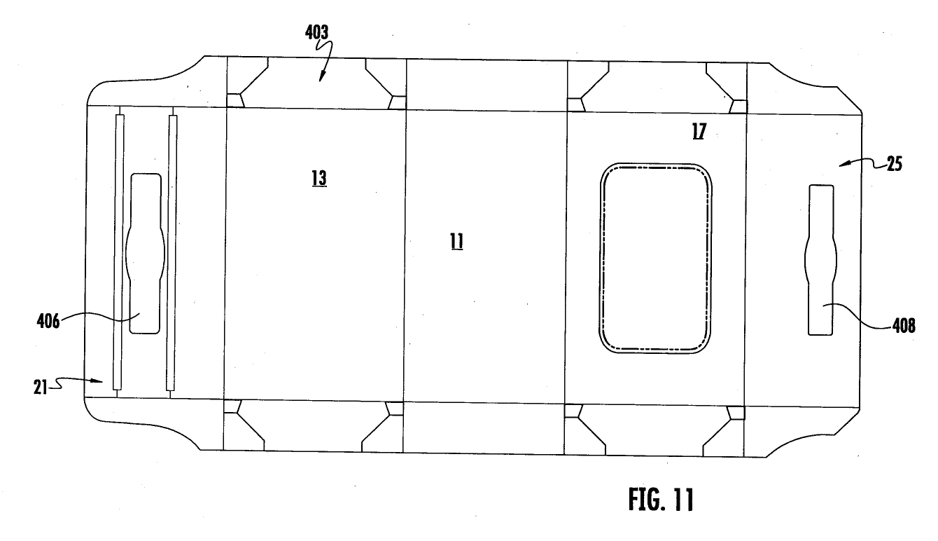

FIG. 11 shows a blank 403 of a third embodiment of the disclosure having similar features as the first embodiment. Accordingly, similar or identical features of the embodiments are provided with identical or similar reference numbers. The blank 403 includes a handle portion 406 in the first top panel 21 and a handle portion 408 in the second top panel 25 for forming the handle of the carton.

In general, the blank may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for carrying a plurality of articles, comprising:
a plurality of panels extending at least partially around an interior of the carton, the plurality of panels comprises at least a first top panel, a second top panel, at least one side panel, and a bottom panel, the first top panel and the second top panel being at least partially overlapped, at least one of the first top panel and the second top panel comprises a main portion foldably connected to the at least one side panel and a distal portion foldably connected to the main portion, the main portion having a first handle portion and the distal portion having a second handle portion, the distal portion having an exterior surface at least partially in face-to-face contact with the interior surface of the main portion; and
a handle comprising at least the first handle portion and the second handle portion.

2. The carton of claim 1 wherein the first handle portion is foldably connected to the second handle portion.

3. The carton of claim 2 wherein the interior surface of the first handle portion is in face-to-face contact with at least a portion of the interior surface of the second handle portion.

4. The carton of claim 1 wherein the main portion is in the first top panel and has at least one opening, the second top panel being adhesively attached to the distal portion of the first top panel by way of the opening.

5. The carton of claim 4 wherein adhesive applied to one of the distal portion and the second top panel is in contact with the distal portion and the second top panel through the opening.

6. The carton of claim 1 wherein the second top panel comprises a third handle portion, the first handle portion, the second handle portion, and the third handle portion comprising three plies of material that form the handle.

7. The carton of claim 6 wherein the third handle portion is in face-to-face contact with at least a portion of the first handle portion.

8. The carton of claim 7 wherein the first handle portion has at least one opening, the third handle portion being adhesively attached to the second handle portion by way of the opening.

9. The carton of claim 8 wherein adhesive applied to one of the second handle portion and the third handle portion is in contact with the second handle portion and the third handle portion through the opening.

10. The carton of claim 1 wherein the distal portion comprises a leading edge portion and the main portion comprises a handle opening adjacent the first handle portion, the leading edge portion is inserted through the opening.

11. The carton of claim 10 wherein the leading edge portion overlaps at least a portion of the main portion, the leading edge portion being in face-to-face contact with the main portion and at least a portion of one of the first top panel and the second top panel to form a reinforced handle portion.

12. The carton of claim 1 further comprising a plurality of end flaps foldably connected to a respective panel of the plurality of panels, the end flaps are configured to at least partially close at least one end of the carton.

13. The carton of claim 12 wherein the plurality of end flaps comprises gusseted end flaps configured to provide gusset corners of the carton.

14. The carton of claim 1 further comprising:
a display opening in the at least one side panel, the display opening allowing viewing of at least one article of the plurality of articles.

15. The carton of claim 1 wherein the second top panel comprises an opening, the opening being for accessing the handle.

16. The carton of claim 1 wherein the second top panel comprises an adhesive flap, the adhesive flap being folded to comprises two plies of material at a distal edge of the second top panel and being in face-to-face contact with the distal portion of the first top panel.

17. A blank for forming a carton for carrying a plurality of articles, the blank comprising:
a plurality of panels comprising at least a first top panel, a second top panel, at least one side panel, and a bottom panel, the first top panel and the second top panel configured to be at least partially overlapped, at least one of the first top panel and the second top panel comprises a main portion foldably connected to the at least one side panel and a distal portion foldably connected to the main portion, the main portion having a first handle portion and the distal portion having a second handle portion, the distal portion having an exterior surface configured to be at least partially in face-to-face contact with the interior surface of the main portion; and
features for forming a handle comprising at least the first handle portion and the second handle portion.

18. The blank of claim 17 wherein the first handle portion is foldably connected to the second handle portion.

19. The blank of claim 18 wherein the interior surface of the first handle portion is configured to be in face-to-face contact with at least a portion of the interior surface of the second handle portion.

20. The blank of claim 17 wherein the main portion is in the first top panel and has at least one opening configured to receive adhesive.

21. The blank of claim 17 wherein the second top panel comprises a third handle portion, the first handle portion, the second handle portion, and the third handle portion comprising three plies of material for forming the handle.

22. The blank of claim 21 wherein the third handle portion is configured to be in face-to-face contact with at least a portion of the first handle portion.

23. The blank of claim 22 wherein the first handle portion has at least one opening configured to receive adhesive.

24. The blank of claim 17 wherein the distal portion comprises a leading edge portion and the main portion comprises a handle opening adjacent the first handle portion, the leading edge portion configured to be inserted through the opening.

25. The blank of claim 17 further comprising a plurality of end flaps foldably connected to a respective panel of the plurality of panels, the end flaps are configured to at least partially close at least one end of the carton.

26. The blank of claim 25 wherein the plurality of end flaps comprises gusseted end flaps configured to provide gusset corners of the carton.

27. The blank of claim 17 further comprising:
a display opening in the at least one side panel, the display opening allowing viewing of at least one article of the plurality of articles.

28. The blank of claim 17 wherein the second top panel comprises an opening, the opening being for accessing the handle.

29. A method of forming a carton for carrying a plurality of articles, the method comprising:
obtaining a blank comprising a plurality of panels comprising at least a first top panel, a second top panel, at least one side panel, and a bottom panel, the first top panel and the second top panel configured to be at least partially overlapped, at least one of the first top panel and the second top panel comprises a main portion foldably connected to the at least one side panel and a distal portion foldably connected to the main portion, the main portion having a first handle portion and the distal portion having a second handle portion, the distal portion having an exterior surface configured to be at least partially in face-to-face contact with the interior surface of the main portion, and features for forming a handle comprising at least the first handle portion and the second handle portion;
forming at least a portion of an interior of the carton by folding the plurality of panels about the plurality of articles; and
forming the handle by positioning the distal portion so that the exterior surface of the distal portion is in face-to-face contact with the interior surface of the main portion, the positioning the distal portion comprises positioning the first handle portion relative to the second handle portion to form the handle.

30. The method of claim 29 wherein the first handle portion is foldably connected to the second handle portion and the forming the handle comprises positioning the interior surface of the first handle portion in face-to-face contact with at least a portion of the interior surface of the second handle portion.

31. The method of claim 29 wherein the main portion of the first top panel has at least one opening, the forming the handle comprises adhesively attaching the second top panel and the distal portion of the first top panel by way of the opening.

32. The method of claim 31 wherein the forming the handle comprises applying adhesive to one of the distal portion and the second top panel so that the adhesive is in contact with the distal portion and the second top panel through the opening.

33. The method of claim 29 wherein the second top panel comprises a third handle portion, the forming the handle comprises positioning the first handle portion, the second handle portion, and the third handle portion comprising to form three plies of material that form the handle.

34. The method of claim 33 wherein the forming the handle comprises positioning the third handle portion to be in face-to-face contact with at least a portion of the first handle portion.

35. The method of claim 33 wherein the first handle portion has at least one opening, the forming the handle comprises adhesively attaching the third handle portion to the second handle portion by way of the opening.

36. The method of claim 35 wherein the forming the handle comprises applying adhesive to one of the second handle portion and the third handle portion so that the adhesive is in contact with the second handle portion and the third handle portion through the opening.

37. The method of claim 29 wherein the distal portion comprises a leading edge portion and the main portion comprises a handle opening adjacent the first handle portion, the forming the handle comprises inserting the leading edge portion through the opening.

38. The method of claim 37 wherein the forming the handle comprises forming a reinforced handle portion by placing the leading edge portion to overlap at least a portion of the main portion and by placing the leading edge portion in face-to-face contact with the main portion and at least a portion of one of the first top panel and the second top panel.
